(19) United States
(12) Patent Application Publication
(10) Pub. No.: US 2010/0277923 A1
(43) Pub. Date: Nov. 4, 2010

(54) LIQUID LENS ELEMENT AND ILLUMINATION APPARATUS

(75) Inventors: Yuichi Takai, Tokyo (JP); Mariko Obinata, Kanagawa (JP); Miki Tsuchiya, Kanagawa (JP); Hiroaki Ishiguro, Aichi (JP)

Correspondence Address: K&L Gates LLP, P. O. BOX 1135, CHICAGO, IL, 60690, US

(73) Assignees: SONY CORPORATION, Tokyo (JP); SONY EMCS CORPORATION, Tokyo (JP)

(21) Appl. No.: 12/547,966

(22) Filed: Aug. 26, 2009

(30) Foreign Application Priority Data
Aug. 28, 2008 (JP) 2008220527

(51) Int. Cl. F21V 7/00; G02B 3/14

(52) U.S. Cl. 362/296.01; 359/666

(57) ABSTRACT

Disclosed is a liquid lens element. The liquid lens element includes a main body, a lens surface, and a first reflection surface. The main body has a light incident surface and a light exiting surface and includes a liquid chamber formed therein. The lens surface changes orientation of light that exits the light exiting surface by being electrically deformed, and the lens surface is formed of an interface between two liquids that are contained in the liquid chamber and have different refractive indexes. The first reflection surface reflects part of light that enters the light incident surface toward an optical axis of the lens surface, and the first reflection surface is provided to the main body.

### CROSS REFERENCES TO RELATED APPLICATIONS

The present application claims priority to Japanese Priority Patent Application JP 2008-220527 filed in the Japan Patent Office on Aug. 28, 2008, the entire contents of which is hereby incorporated by reference.

### BACKGROUND

The present invention relates to a liquid lens element and an illumination apparatus using an electrowetting effect.

In recent years, an optical element that uses an electrowetting (electrocapillary phenomenon) effect is being developed. The electrowetting effect refers to a phenomenon in which voltage application to an electrode and a liquid having electrical conductivity through an insulator causes the liquid to be electrically charged, thereby reducing an interface free energy, resulting in a change in shape (curvature) of a gas-liquid interface or a liquid-liquid interface.

There has been proposed a liquid lens in which, with the use of the above-mentioned phenomenon, a two-liquid interface is deformed to change a focal length by applying a voltage to the two liquids that are contained in a liquid chamber and have different refractive indexes.

For example, Japanese Patent Application Laid-open No. 2007-212943 (paragraph 0087, FIG. 9) (hereinafter, referred to as Patent Document 1) discloses an optical element that is a liquid lens as described above.

In the optical element disclosed in Patent Document 1, a silicon substrate having a through hole, a first transparent substrate bonded to one surface of the silicon substrate to block one end of the through hole, and a second transparent substrate oppositely disposed on the other surface of the silicon substrate with a sealing layer intervening therebetween constitute a cell for containing a liquid.

On an inner surface of the through hole, an insulating layer having water repellency is formed, and a first liquid having conductivity and a second liquid which has a insulation property and a refractive index different from that of the first liquid and is not mixed with the first liquid are filled in the cell so that an interface between the two liquid is positioned in the through hole mentioned above. The two-liquid interface is an interface between the two liquids whose refractive indexes are different. Accordingly, light that passes through the interface gains a lens effect and is refracted.

When a voltage is applied between the first liquid and the silicon substrate, the shape (curvature) of the two-liquid interface is changed. As a result, light that passes through the two-liquid interface is diffused or converged as compared to a case where a voltage is not applied.

With this structure, incident light passes through the first and second transparent substrates and the first and second liquids to be output. For example, by configuring those components by a high-light-transmissive material or by increasing the size of an opening of the through hole, it is possible to increase the amount of exiting light that can be used in a desirable optical axis direction, of the incident light.

### SUMMARY

However, the optical element disclosed in Patent Document 1 includes the silicon substrate having no (or small) light transmission property, so incident light is partly blocked. Further, even when a substrate corresponding to the silicon substrate is made of a high-light-transmissive material such as a glass substrate, light that passes through the substrate does not gain a lens effect by the cell (two-liquid interface), which makes a little contribution to the amount of light in the desirable optical axis direction.

In view of the above-mentioned circumstances, it is desirable to provide a liquid lens element and an illumination apparatus that can improve a use efficiency of incident light.

According to an embodiment, there is provided a liquid lens element including a main body, a lens surface, and a first reflection surface.

The main body has a light incident surface and a light exiting surface and includes a liquid chamber formed therein.

The lens surface changes orientation of light that exits the light exiting surface by being electrically deformed, the lens surface being formed of an interface between two liquids that are contained in the liquid chamber and have different refractive indexes.

The first reflection surface reflects part of light that enters the light incident surface toward an optical axis of the lens surface, the first reflection surface being provided to the main body.

With this structure, it is possible to reflect, by the first reflection surface, light that enters an area excluding the liquid chamber in the liquid lens element. Light that enters the area excluding the liquid chamber on the light incident surface is reflected in the optical axis direction without being blocked by the main body, thereby making it possible to use incident light efficiently.

The main body may include a first substrate, a second substrate, and a third substrate.

The first substrate forms the light exiting surface.

The second substrate forms the light incident surface.

The third substrate is disposed between the first substrate and the second substrate and has a through hole that forms a side circumferential surface of the liquid chamber.

With this structure, the through hole formed in the third substrate and the first and second substrates constitute the liquid chamber. By filling the two liquids whose refractive indexes are different in the liquid chamber, the liquid lens element is formed.

The first reflection surface may be provided on the side circumferential surface of the liquid chamber.

With this structure, light that reaches the side circumferential surface of the liquid chamber is reflected in the optical axis direction and therefore can be added to the light amount in the optical axis direction.

The third substrate may have an insulation property, and the main body may further include a conductive layer and an insulating layer.

The conductive layer is provided on the side circumferential surface of the liquid chamber.

The insulating layer covers the conductive layer.

With this structure, because the third substrate has the insulating property, it is possible to reduce a parasitic capacitance between the third substrate and the conductive liquid, which is generated in a case where the third substrate has the conductive property. By providing the first reflection surface to the liquid lens element, it is possible to form a liquid lens element in which the use efficiency of incident light is further increased.

The first reflection surface may be the conductive layer.

With this structure, the use of the conductive layer for the reflection surface can make it unnecessary to further provide another first reflection surface.

The third substrate may have a light transmission property, and the first reflection surface may be provided on an outer circumferential portion of the main body.

With this structure, when the third substrate has the light transmission property, it is possible to use light that passes through the third substrate and reaches the outer circumferential portion of the main body by reflecting the light.

The third substrate may have an insulation property, and the main body may further include a conductive layer and an insulating layer.

The conductive layer is provided on the side circumferential surface of the liquid chamber.

The insulating layer covers the conductive layer.

The third substrate may have a light transmission property, and the first reflection surface may be provided on the side circumferential surface of the liquid chamber. The liquid lens element may further include a second reflection surface.

The second reflection surface is provided on an outer circumferential portion of the main body.

With this structure, light that reaches the side circumferential surface of the liquid chamber can be reflected by the first reflection surface and light that reaches the outer circumferential portion of the main body can be reflected by the second reflection surface, with the result that the reflected light can be used.

The third substrate may have an insulation property, and the main body may further include a conductive layer and an insulating layer.

The conductive layer is provided on the side circumferential surface of the liquid chamber.

The insulating layer covers the conductive layer.

According to another embodiment, there is provided an illumination apparatus including a main body, a lens surface, an inner reflection surface, a light source, and a light-collecting surface.

The main body has a light incident surface and a light exiting surface and includes a liquid chamber formed therein.

The lens surface changes orientation of light that exits the light exiting surface by being electrically deformed, the lens surface being formed of an interface between two liquids that are contained in the liquid chamber and have different refractive indexes.

The inner reflection surface reflects part of light that enters the light incident surface toward an optical axis of the lens surface, the inner reflection surface being provided to the main body.

The light source emits light that enters the light incident surface.

The light-collecting surface converges light emitted from the light source toward the liquid chamber.

With this structure, light emitted from the light source and collected by the light-collecting surface can be oriented on the lens surface. By reflecting light that reaches the inner reflection surface in the optical axis direction in the main body, it is possible to increase the use efficiency of light. In addition, it is also possible to change optical characteristics of the illumination apparatus depending on the degrees of collected light to the inner reflection surface of the liquid lens element by the light-collecting surface.

The illumination apparatus may further include an outer reflection surface.

The outer reflection surface reflects light emitted from the light source toward the light-collecting surface, the outer reflection surface being disposed in an outside area of the liquid chamber on the light incident surface.

With this structure, light that deviates from the main body is reflected again by the outer reflection surface to the light-collecting surface, with the result that the use efficiency can be further increased.

As described above, according to an embodiment, it is possible to provide the liquid lens element and the illumination apparatus that can increase the use efficiency of incident light.

These and other objects, features and advantages will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a cross-sectional view showing a liquid lens element according to a first embodiment;

FIG. 2 is a plan view showing the liquid lens element;

FIG. 3 is a diagram showing a path of light that enters the liquid lens element;

FIG. 4 is a graph showing a simulation result of liquid lens elements;

FIG. 5 is a table showing the simulation result of the liquid elements;

FIG. 6 is a cross-sectional view showing a liquid lens element according to a second embodiment;

FIG. 7 is a cross-sectional view showing a liquid lens element according to a third embodiment;

FIG. 8 is a cross-sectional view showing an illumination apparatus according to a fourth embodiment; and

FIG. 9 is a cross-sectional view showing an illumination apparatus according to a fifth embodiment.

### DETAILED DESCRIPTION

Hereinafter, an optical element according to an embodiment will be described with reference to the drawings.

### First Embodiment

A liquid lens element 1 according to a first embodiment will be described.

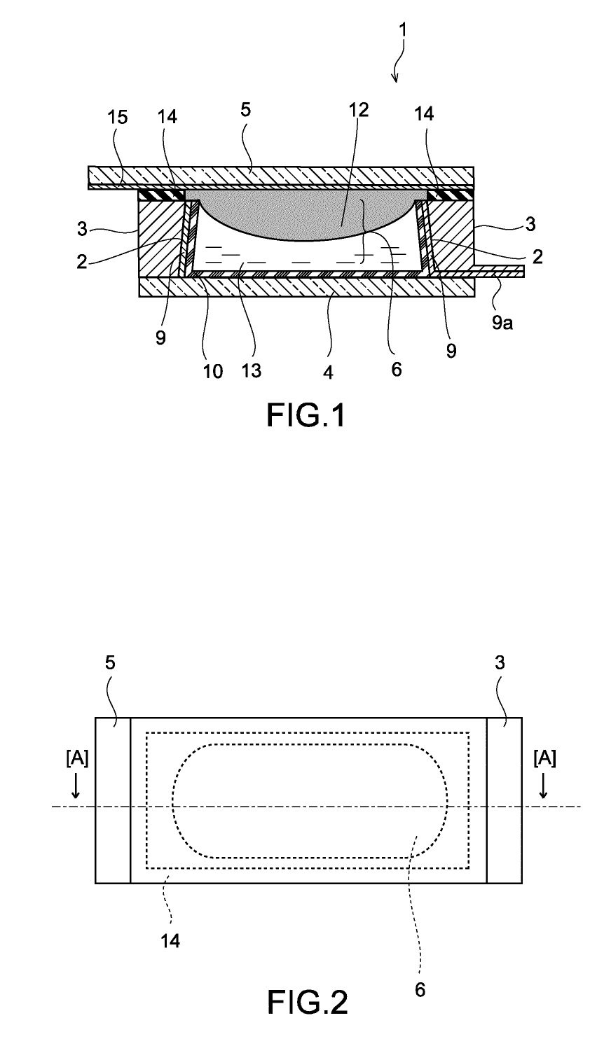

FIG. 1 is a cross-sectional view of the liquid lens element 1 according to this embodiment, and FIG. 2 is a plan view of the liquid lens element 1. FIG. 1 shows the cross-sectional view taken along the line [A]-[A] of FIG. 2. As shown in the figures, the liquid lens element 1 includes a third substrate 3 having a through hole 2, a first substrate 4, and a second substrate 5.

The third substrate 3 is disposed between the first substrate 4 and the second substrate 5, and a space formed by the through hole 2, the first substrate 4, and the second substrate 5 serves as a liquid chamber 6 that contains a first liquid 12 having conductivity and a second liquid 13 having an insulation property.

The first substrate 4 and the third substrate 3 are bonded by welding, ultrasonic welding, diffusion bonding, caulking, screw clamping, anodic bonding, or the like.

The second substrate 5 and the third substrate 3 are engaged with each other by a clamp mechanism (not shown) or the like through a sealing member 14 made of elastomer or the like.

The third substrate 3 can be made of an insulating synthetic resin material having a high light transmission property (such as acryl, PET (polyethylene terephthalate), and polycarbonate), glass, ceramics, or the like as appropriate. By using the material having the high light transmission property, it is possible to reduce a loss of the intensity of light that passes through the liquid lens element 1. The third substrate 3 may instead be made of a material that does not cause light to pass therethrough, such as a resin, ceramics, metal, or the like as necessary.

The through hole 2 formed in the third substrate 3 structures a side circumferential surface of the liquid chamber 6. The through hole 2 according to this embodiment has an oval opening, but the shape of the opening is not limited to the oval shape and may instead be a circular or rectangular shape, for example. In addition, a plurality of through holes 2 may be arranged in an array. Tilt angles of a side wall of the through hole 2 with respect to the first substrate 4 and the second substrate 5 affect the shape (curvature) of the two-liquid interface serving as a lens surface, and are therefore determined in accordance with desired optical characteristics. It should be noted that the side wall of the through hole 2 may be perpendicular to the first substrate 4 and the second substrate 5 or may have a curved shape.

On a circumferential surface of the through hole 2, a conductive layer 9 is formed.

The conductive layer 9 is a thin film having conductivity. The conductive layer 9 is made of a material having high reflectance, such as aluminum, silver, and an alloy of aluminum or silver with another metal, and is formed by a vacuum deposition method, a sputtering method, or the like. A surface of the conductive layer 9 on the liquid chamber 6 side (surface in contact with an insulating layer 10) is formed so as to reflect light.

A part of the conductive layer 9 is formed on the third substrate 3 on the first substrate 4 side, and functions as a first electrode 9a for applying a voltage to the conductive layer 9 from an external power source (not shown).

On the conductive layer 9 and the first substrate 4 on the liquid chamber 6 side, the insulating layer 10 is formed. The insulating layer 10 has to completely cover the conductive layer 9 so that the conductive layer 9 is prevented from being in contact with a liquid contained in the liquid chamber 6 (described later). The insulating layer 10 is made of a material having a high dielectric constant, water repellency, and a light transmission property. By giving the light transmission property to the insulating layer 10, light that reaches the side circumferential surface of the liquid chamber 6 can be caused to pass therethrough and reach the conductive layer 9.

Examples of the material of the insulating layer 10 which satisfies the above conditions include parylene (poly-para-xylylene-based resin), PVDF (polyvinylidene difluoride), and a silicone oxide layer. Those can be formed by a CVD (chemical vapor deposition) method or a coating method, for example.

The first substrate 4 and the second substrate 5 each are formed of a glass substrate, a ceramic substrate, a nonconductive plastic, or the like. Those substrates are made of a material having the high light transmission property (described later).

In the liquid lens element 1 according to this embodiment, light enters the second substrate 5 and exits the first substrate 4. Accordingly, the outer surface of the second substrate 5 serves as a light incident surface and the outer surface of the first substrate 4 serves as a light exiting surface. It should be noted that light may enter the first substrate 4 and exit the second substrate 5.

On the surface of the second substrate 5 on the liquid chamber 6 side, a second electrode 15 for applying a voltage to the first liquid 12 from the external power source (not shown) is formed. The second electrode 15 is made of a transparent electrode material such as an ITO (indium tin oxide).

The liquid chamber 6 contains the first liquid 12 and the second chamber 13. Those two liquids are not miscible with each other and have different absolute refractive indexes. In a case where the two liquids are mixed, the two-liquid interface is not generated, and if the refractive indexes are the same, the optical characteristics caused by the shape of the interface are not be obtained. Further, by setting specific gravities of the two liquids to be equal, it can be prevented that the two-liquid interface significantly changes in response to the vibration or the like of the liquid lens element 1 and the optical characteristics are affected.

The first liquid 12 is a conductive or polar liquid, and desirably has a high light transmissivity. For the first liquid 12, water, an electrolyte (such as sodium chloride solution and lithium chloride solution), alcohol (such as methanol and ethanol), an ambient temperature molten salt, or the like can be used. In this embodiment, a lithium chloride solution (3.36 wt %, absolute refractive index of 1.34) is used for the first liquid 12.

The second liquid 13 is an insulating liquid. A liquid having a high light transmissivity can be used therefor. For the second liquid 13, carbohydrate (such as decane, dodecane, and hexadecane), hydrophobic silicone oil, or the like can be used. In this embodiment, silicone oil (TSF437 manufactured by Momentive Performance Materials, Inc., absolute refractive index of 1.49) is used for the second liquid 13.

As shown in FIG. 1, when the first liquid 12 and the second liquid 13 are contained in the liquid chamber 6, the two liquids are separated into two layers because of their immiscibility. In this embodiment, because the insulating layer 10 having water repellency is formed on the circumferential surface of the through hole 2 of the third substrate 3 and on the surface of the first substrate 4 on the liquid container side (hereinafter, referred to as water-repellent area), the first liquid 12 having a high surface energy is repelled and gathered to the second substrate 5 side, and the second liquid 13 is spread on the water-repellent area and gathered to the first substrate 4 side.

As a result, the two-liquid interface (i.e., lens surface) having different refractive indexes is generated. The two-liquid interface becomes a curved surface having a curvature determined by a surface free energy between the two liquids and between each of the two liquids and the insulating layer 10.

Next, a description will be given on an operation of the liquid lens element 1 structured as described above.

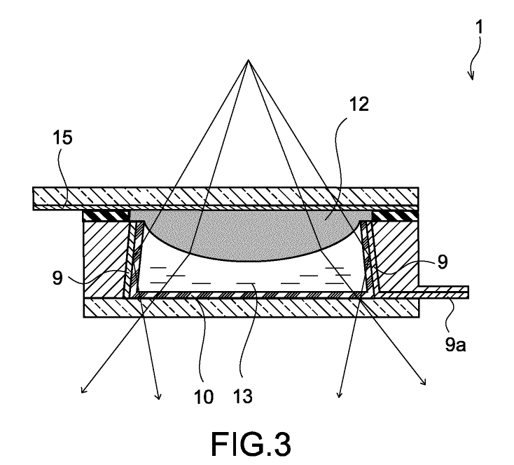

FIG. 3 is a diagram showing an optical path that enters the liquid lens element 1.

As shown in FIG. 3, light that enters the two-liquid interface is refracted depending on an incident angle because the first liquid 12 and the second liquid 13 have different absolute refractive indexes.

When a voltage is applied to the first electrode 9a and the second electrode 15 of the liquid lens element 1, the two-liquid interface is deformed by the electrowetting effect as follows.

When the voltage is applied, an electrostatic potential is generated, and charges in the first liquid 12 and the conductive layer 9 are moved. As a result, different charges are accumulated on the surface of the first liquid 12 and on the conductive layer 9 through the insulating layer 10 and the second liquid 13, thereby structuring a capacitor. When the charges are pulled together, a contact angle of the two-liquid interface is changed, and thus the curvature of the two-liquid interface is also changed (electrowetting effect). That is, the deformation of the lens surface is caused. Therefore, exiting light is converged or diffused (converged in this embodiment) as compared to a case where the voltage is not applied.

Here, light that enters the liquid lens element 1 includes light that reaches the circumferential surface of the through hole 2 in addition to light that reaches the two-liquid interface as described above. This light passes through the insulating layer 10 having the light transmission property and reaches the conductive layer 9. The conductive layer 9 according to this embodiment has reflectivity. Therefore, light that reaches the conductive layer 9 is reflected and travels in an optical axis direction. As a result, it is possible to use the larger amount of light in the optical axis direction as compared to a case where the conductive layer 9 does not have reflectivity. This is particularly effective in a case where the size (opening size, thickness, and size of the element) of the liquid lens element 1 is small. In addition, because the conductive layer 9 is formed on the wall surface of the through hole 2, it is possible to adjust a reflection direction of the reflection light by adjusting the tilt angle of the wall surface of the through hole 2.

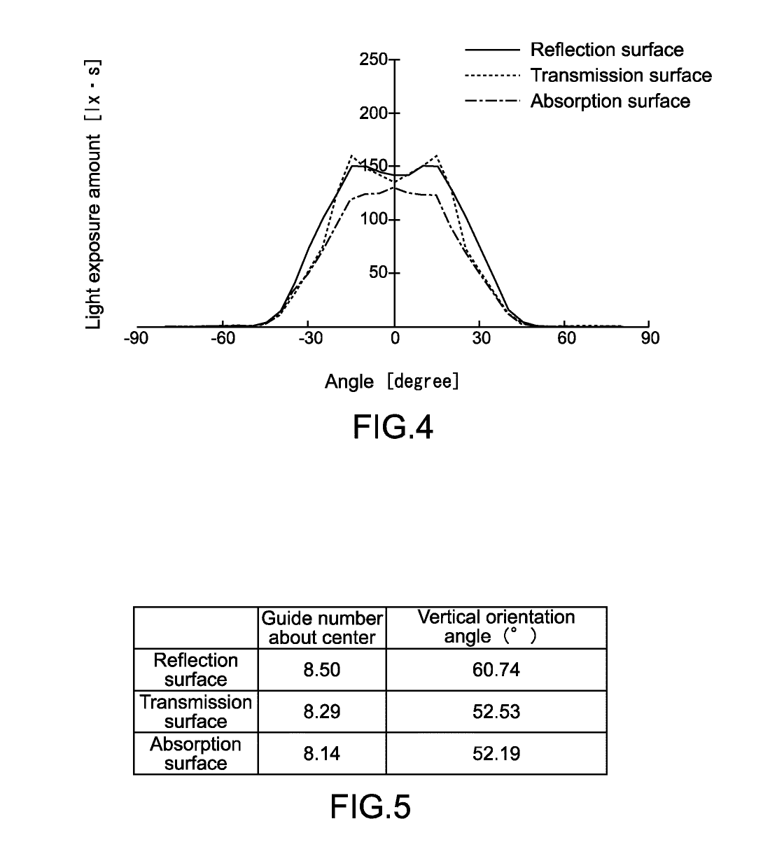

FIG. 4 is a graph showing optical characteristics of various liquid lens elements.

FIG. 5 is a table showing the optical characteristics of the various liquid elements.

FIG. 4 shows a result obtained by conducting simulations on the liquid lens element in the state where the voltage was not applied, regarding distributions of a light exposure amount after incident light from the light source passed through the liquid lens element. The graph of FIG. 4 is obtained by plotting the light exposure amount (lx·s) with respect to an orientation angle. An angle of 0 degree corresponds to the optical axis (front direction).

FIG. 5 shows a result of the simulations regarding the orientation angle in a vertical direction and a guide number about the optical axis.

The liquid lens element used for the above simulation had a liquid chamber of 4 mm in width, 22 mm in length, and 2 mm in height, first and second substrates of 0.5 mm in thickness, a conductive liquid having a refractive index of 1.33, and an insulating liquid having a refractive index of 1.50. A light source was a xenon tube (16.5 mm×Φ2.0 mm).

The conductive layer of the liquid lens element was a reflection surface (aluminum layer, reflectance of 75%), an absorption surface (aluminum oxide, reflectance of 0%), and a transmission surface (acryl), and the simulation results were obtained for each.

As shown in FIG. 4, in a case where the conductive layer was the absorption surface, a large loss of light amount was caused and the smallest light exposure amount was obtained. In a case there the conductive layer was the reflection surface, the light exposure amount was increased at about ±30 degrees. An effect by setting the reflection surface as the conductive layer was obtained. In addition, as shown in FIG. 5, in terms of a guide number about the optical axis, the light exposure amount was also increased in the case where the reflection surface was used.

### Second Embodiment

Next, a liquid lens element 20 according to a second embodiment will be described.

Descriptions of structures and operations of the liquid lens element 20 that are the same as those of the liquid lens element 1 according to the first embodiment will be simplified or omitted, and different points will be mainly described. The same holds true for the subsequent embodiments.

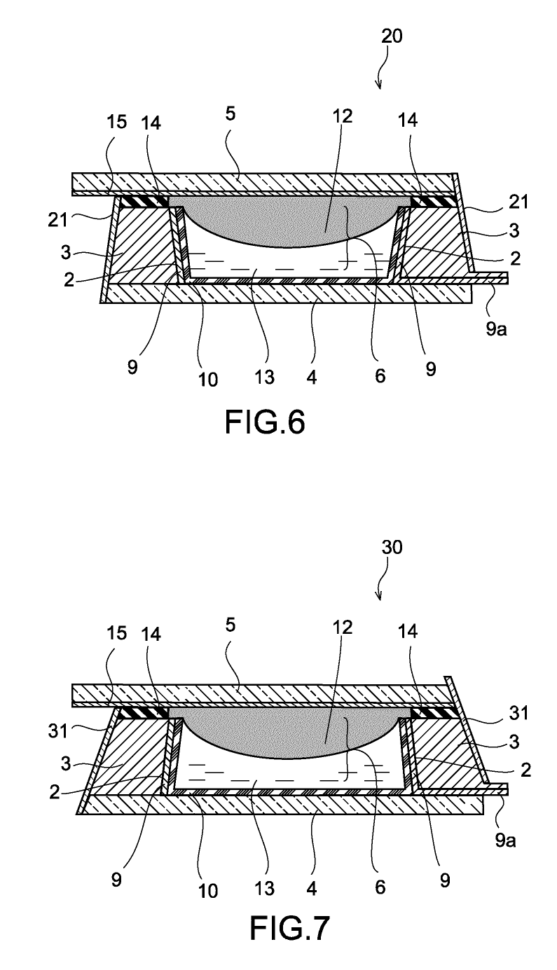

FIG. 6 is a cross-sectional view of the liquid lens element 20 according to this embodiment.

As shown in FIG. 6, the liquid lens element 20 includes a reflection layer 21. The reflection layer 21 is provided on an outer circumferential portion (outer surface excluding the light incident surface and the light exiting surface) of the third substrate 3, the first substrate 4, and the second substrate 5. The reflection layer 21 is made of a material such as aluminum and formed by a vacuum deposition method, for example. The surfaces of the liquid lens element 20 on the third substrate 3 side, the first substrate 4 side, and the second substrate 5 side are the reflection surfaces. The conductive layer 9 of the liquid lens element 20 may not necessarily have the reflectivity unlike the conductive layer 9 of the first embodiment. The third substrate 3 is made of a material having a high light transmission property, such as glass and acryl, to cause light to pass through the third substrate 3 unlike the third substrate of the first embodiment.

Part of light that enters the liquid lens element 20 passes through the conductive layer 9, the insulating layer 10, and the third substrate 3 that have the light transmission property, or passes through the third substrate 3 and reaches the reflection layer 21 without passing through the conductive layer 9 and the insulating layer 10.

Light that reaches the reflection layer 21 is reflected by the reflection layer 21 toward the optical axis direction. As a result, a larger amount of light can be used in the optical axis direction as compared to a case where the reflection layer 21 is not provided.

In the liquid lens element 1 according to the first embodiment, the conductive layer 9 is used as the reflection surface. But, the conductive layer 9 is formed on the circumferential surface of the through hole 2, and therefore the position and the orientation angle of the conductive layer 9 is limited. This is because the deformation of the two-liquid interface by the electrowetting effect described above is affected by the contact angle between the two-liquid interface and the through hole 2 (conductive layer 9 and insulating layer 10 formed thereon). It should be noted that the insulating layer 10 intervenes between the conductive layer 9 and the first liquid 12 as a dielectric body and thus the thickness of the insulating layer 10 is not arbitrarily set.

That is, in the case where the conductive layer 9 is used as the reflection surface, it is difficult to arbitrarily set the position and the orientation angle of the conductive layer 9. The reflection layer 21 according to the second embodiment is formed on the outer circumference of the third substrate 3, and therefore the position and the orientation angle of the reflection layer 21 can be arbitrarily set.

### Third Embodiment

Next, a liquid lens element 30 according to a third embodiment will be described.

FIG. 7 is a cross-sectional view of the liquid lens element 30 according to this embodiment.

As shown in FIG. 7, the liquid lens element 30 includes the conductive layer 9 serving as the reflection surface and a reflection layer 31. The reflection layer 31 is made of a material having high reflectivity, such as an aluminum layer. The third substrate 3 is made of a material having a high light transmission property, such as glass and acryl.

Out of incident light, light that reaches the conductive layer 9 is reflected by the conductive layer 9 in the optical axis direction. In addition, light that passes through the third substrate 3 and reaches the reflection layer 31 is also reflected by the reflection layer 31 in the optical axis direction. As a result, a use efficiency of incident light can be improved. Further, the orientation angles of the conductive layer 9 and the reflection layer 31 with respect to the light source are set to be different, thereby making it possible to reflect light beams whose incident angles are different.

It is also possible to use a half mirror for the conductive layer 9. In this case, out of light that reaches the conductive layer 9, the conductive layer 9 reflects light at an angle that can be easily reflected and causes light at an angle that is difficult to be reflected to pass therethrough. Light that passes through the conductive layer 9 is reflected by the reflection layer 31.

Further, reflectivity is given to a rear surface (surface on the third substrate 3 side) of the conductive layer 9, thereby making it possible to cause light reflected by the reflection layer 31 to be reflected by the rear surface of the conductive layer 9 and reflected by the reflection layer 31 again. This is effective for a case where a distance between the light source and the liquid lens element 30 is short and an angle of light that reaches the reflection layer 31, out of incident light, with respect to the optical axis is large, for example.

### Fourth Embodiment

Next, an illumination apparatus 40 according to a fourth embodiment will be described.

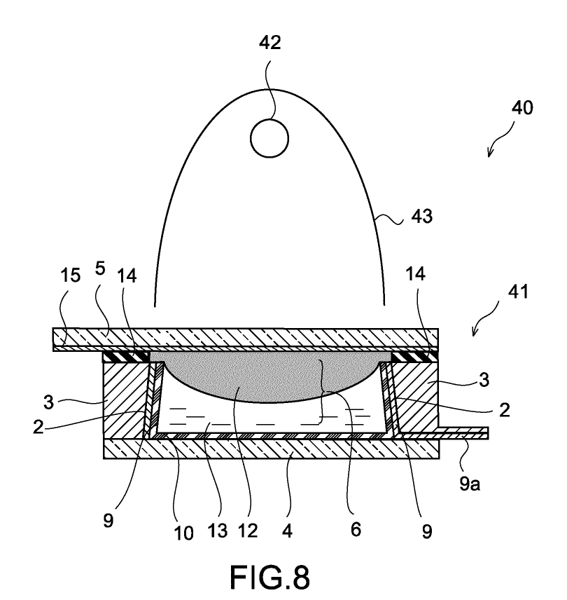

FIG. 8 is a cross-sectional view showing the illumination apparatus 40 according to this embodiment.

As shown in FIG. 8, the illumination apparatus 40 includes a liquid lens element 41, a light source 42, and a light-collecting surface 43.

The light source 42 is disposed by a predetermined distance on the side of the second substrate 5 of the liquid lens element 41. The light-collecting surface 43 is disposed so as to cover a space expanding from the light source 42 to the second substrate 5 from a back surface side of the light source 42 (opposite surface side to the liquid lens element 41), for example.

The liquid lens element 41 corresponds to one of the liquid lens elements according to the first to third embodiments and includes a reflection surface (inner reflection surface) provided inside the liquid lens element 41 (including the outer periphery of the third substrate 3) as described above.

The light source 42 is a light emitting element such as a xenon tube and an LED (light emitting diode).

The light-collecting surface (reflector) 43 is formed of, e.g., a metal plate whose inner surface is subjected to mirror-like finishing and formed into a shape that allows light emitted from the light source 42 to be reflected in the optical axis direction and collected in a front direction (for example, paraboloidal surface shape). Further, instead of the light-collecting surface 43, an optical member such as a light guide that transmits light by repeatedly performing total reflection at an interface between an inside of a transparent body and an air layer can be used.

Light emitted from the light source 42 is partly directly transmitted to the liquid lens element 41 and is partly reflected by the light-collecting surface 43 and transmitted to the liquid lens element 41. Light that enters the second substrate 5 passes through the interface (lens surface) between the two liquids 12 and 13 and gains the lens effect, to exit the first substrate 4. A focal length of the two-liquid interface can be adjusted by performing the electrical deformation thereof as described above. Light that travels not toward the light exiting surface (first substrate 4) but toward the circumferential surface of the liquid chamber 6 is reflected by the reflection surface (conductive layer 9) and oriented in the optical axis direction (front direction). As a result, the amount of light in the optical axis direction can be increased.

According to this embodiment, a light collection efficiency of light emitted from the light source 42 is increased in the front direction by the light-collecting surface 43, and therefore the light amount in the optical axis direction can be increased as compared to the above embodiments. In addition, by optimizing the position, the angle, the size, and the like of the reflection surface formed by the conductive layer 9, desirable optical characteristics can be obtained. Of course, the light-collecting surface 43 may be optimized depending on the structure of the reflection surface.

In addition, the structure of the light-collecting surface 43 is not limited to the example in which the light-collecting surface 43 is disposed away from the liquid lens element 41 as shown in FIG. 8, and a structure in which the liquid lens element 41 and the light-collecting surface 43 are integrally formed may instead be employed. For example, an end portion of an opening of the light-collecting surface 43 can be integrally bonded to the second substrate 5. With this structure, light can be prevented from leaking between the light-collecting surface 43 and the second substrate 5, with the result that the use efficiency can be further improved.

In addition, a substrate-liquid interface and the two-liquid interface of the liquid lens element 41 have different absolute refractive indexes, so incident light is partly subjected to total reflection. According to this embodiment, the light-collecting surface 43 is disposed on the light incident side of the liquid lens element 41. Therefore, light that is totally reflected and returned in the incident direction can also be reflected by the light-collecting surface 43 again, which can make a great contribution to the improvement of the light use efficiency.

### Fifth Embodiment

Next, an illumination apparatus 50 according to a fifth embodiment will be described.

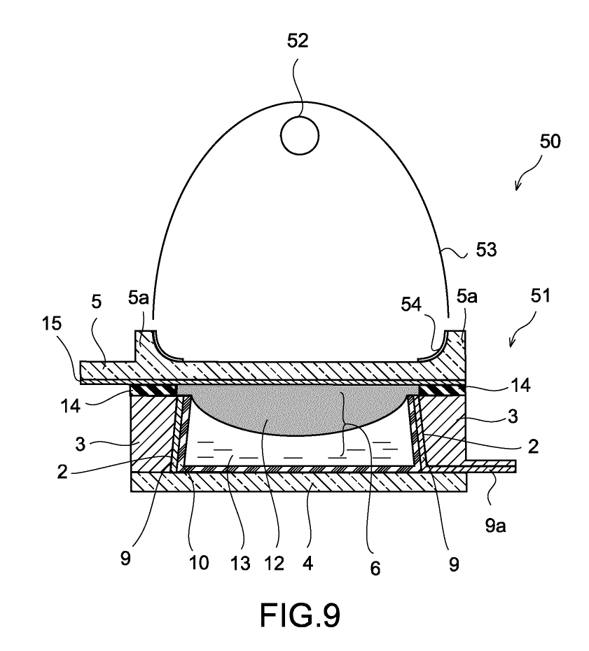

FIG. 9 is a cross-sectional view showing the illumination apparatus 50 according to this embodiment.

As shown in FIG. 9, the illumination apparatus 50 includes a liquid lens element 51, a light source 52, and a light-collecting surface 53. The arrangement of those components is the same as that in the fourth embodiment.

The liquid lens element 51 can be formed by one of the liquid lens elements according to the first to third embodiments. The liquid lens element 51 shown in FIG. 9 includes the inner reflection surface (conductive layer 9) and an outer reflection surface 54 provided on the second substrate 5.

The outer reflection surface 54 is formed on a convex portion 5a protruded toward an opening edge portion of the light-collecting surface 53 on the outside of the second substrate 5 (light incident surface). The convex portion 5a is provided in a peripheral area on the second substrate 5. Here, the peripheral area refers to an area excluding a light incident path area (center area) toward the lens surface on the surface (light incident surface) of the second substrate 5. The outer reflection surface 54 is formed of a white resin layer or a metal layer such as an aluminum layer, which is formed on the surface of the convex portion 5a on the center area side, and formed into a paraboloidal surface shape or the like.

The light source 52 and the light-collecting surface 53 are the same as those in the fourth embodiment.

The liquid lens element 51 is irradiated with light emitted from the light source 52. Out of light that enters the second substrate 5, light that reaches (the convex portion 5a formed on) the peripheral area is reflected by the outer reflection surface 54, is repeatedly reflected by the light-collecting surface 53, and enters the center area of the second substrate 5.

As described above, light that reaches the center area passes through the two-liquid interface (lens surface) and exits the first substrate 4. Light that reaches the inner reflection surface is reflected by the reflection surface (conductive layer 9) in the optical axis direction, with the result that the light amount in the optical axis direction is increased.

According to this embodiment, because the outer reflection surface 54 is provided, light that enters the peripheral area of the second substrate 5 is returned toward the light source 52 and repeatedly reflected by the light-collecting surface 53, with the result that light can be caused to enter the center area. Thus, the light use efficiency can be increased, and the amount of exiting light in the optical axis direction can be increased.

It should be noted that, in the above description, the outer reflection surface 54 is a metal layer formed on the convex portion 5a that is formed integrally with the second substrate 5, but a metal structure having a shape corresponding to the convex portion 5a may be disposed in the peripheral area of the second substrate 5 instead of the convex portion 5a, thereby forming the outer reflection surface. In addition, the convex portion 5a can be continuously or intermittently formed along the area on the second substrate 5, which is opposed to the opening edge portion of the light-collecting surface 53. Further, the shape of the outer reflection surface 54 is not limited to the curved surface as shown in the figure and may instead be a flat surface. Furthermore, the light-collecting surface 53 and the outer reflection surface 54 may be connected to each other.

The present invention is not limited to the above embodiments and various changes can be applied thereto.

In the above embodiments, the structure in which light enters the liquid lens element from the second substrate side is used. Alternatively, light can enter the liquid lens element from the first substrate side. The position and the tilt angle of the reflection surface (inner reflection surface and outer reflection surface) are set so as to correspond to the position of the light source.

The optical elements according to the above embodiments each have the structure in which the conductive layer 9 and the insulating layer 10 are layered on the third substrate 3 having an insulation property, but the structure is not limited to this. It is also possible to form the insulating layer on the third substrate having the conductivity. In this case, when the third substrate is made of a material having reflectivity or when a process of giving reflectivity is performed on the surface of the third substrate 3, the third substrate can function as the reflection surface.

The illumination apparatus according to the fourth and fifth embodiments each include one liquid lens element, one light source, and one light-collecting surface, but the number of those components is not limited to one, respectively. For example, an illumination apparatus in which a plurality of light sources are arranged or an illumination apparatus in which a plurality of liquid lens elements are arranged can be adopted.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A liquid lens element, comprising:
a main body having a light incident surface and a light exiting surface and including a liquid chamber formed therein;
a lens surface to change orientation of light that exits the light exiting surface by being electrically deformed, the lens surface being formed of an interface between two liquids that are contained in the liquid chamber and have different refractive indexes; and
a first reflection surface to reflect part of light that enters the light incident surface toward an optical axis of the lens surface, the first reflection surface being provided to the main body.

2. The liquid lens element according to claim 1,
wherein the main body includes
a first substrate to form the light exiting surface,
a second substrate to form the light incident surface, and
a third substrate disposed between the first substrate and the second substrate, the third substrate having a through hole that forms a side circumferential surface of the liquid chamber.

3. The liquid lens element according to claim 2,
wherein the first reflection surface is provided on the side circumferential surface of the liquid chamber.

4. The liquid lens element according to claim 3,
wherein the third substrate has an insulation property, and
wherein the main body further includes a conductive layer provided on the side circumferential surface of the liquid chamber, and
an insulating layer to cover the conductive layer.

5. The liquid lens element according to claim 4,
wherein the first reflection surface is the conductive layer.

6. The liquid lens element according to claim 2,
wherein the third substrate has a light transmission property, and
wherein the first reflection surface is provided on an outer circumferential portion of the main body.

7. The liquid lens element according to claim 6,
wherein the third substrate has an insulation property, and
wherein the main body further includes a conductive layer provided on the side circumferential surface of the liquid chamber, and
an insulating layer to cover the conductive layer.

8. The liquid lens element according to claim 2,
wherein the third substrate has a light transmission property, and
wherein the first reflection surface is provided on the side circumferential surface of the liquid chamber,
the liquid lens element further comprising:
a second reflection surface provided on an outer circumferential portion of the main body.

9. The liquid lens element according to claim 8,
wherein the third substrate has an insulation property, and
wherein the main body further includes a conductive layer provided on the side circumferential surface of the liquid chamber, and
an insulating layer to cover the conductive layer.

10. An illumination apparatus, comprising:
a main body having a light incident surface and a light exiting surface and including a liquid chamber formed therein;
a lens surface to change orientation of light that exits the light exiting surface by being electrically deformed, the lens surface being formed of an interface between two liquids that are contained in the liquid chamber and have different refractive indexes;
an inner reflection surface to reflect part of light that enters the light incident surface toward an optical axis of the lens surface, the inner reflection surface being provided to the main body;
a light source to emit light that enters the light incident surface; and
a light-collecting surface to converge light emitted from the light source toward the liquid chamber.

11. The illumination apparatus according to claim 10, further comprising:
an outer reflection surface to reflect light emitted from the light source toward the light-collecting surface, the outer reflection surface being disposed in an outside area of the liquid chamber on the light incident surface.
